(19) United States
(12) Patent Application Publication
(10) Pub. No.: US 2021/0039787 A1
(43) Pub. Date: Feb. 11, 2021

(54) CABIN MODULE

(71) Applicant: Dubai Aviation Engineering Projects, Dubai (AE)

(72) Inventors: Rouchdi BOUSTANI, Dubai (AE); Saji FRANCIS, Dubai (AE); Subimal PAUL, Dubai (AE); Cedric CARLE, Dubai (AE); Shaheem PAYKAT, Dubai (AE)

(21) Appl. No.: 16/967,835

(22) PCT Filed: Feb. 8, 2018
(86) PCT No.: PCT/IB2018/050775

§ 371 Date: Aug. 6, 2020

(51) Int. Cl. B64D 11/00

(52) U.S. Cl. CPC B64D 11/00; B64D 2011/0046

(57) ABSTRACT

A cabin module deployable inside a vehicle so as to form at least a portion of an interior of the vehicle. The cabin module comprises a main body and a plurality of external walls. One or more of the plurality of external walls are moveable with respect to the main body. The module has a closed configuration for storage outside the vehicle, in which the plurality of external walls define at least a part of a first form factor of the module. The module has an open configuration for operational deployment in the vehicle, in which the plurality of external walls define at least a part of a second form factor of the module. The cabin module is reversibly changeable between the closed configuration and the open configuration by movement of the one or more external walls. The first form factor is different from the second form factor.

### BACKGROUND OF THE INVENTION

The present disclosure relates to a cabin module.

The aviation industry is evolving rapidly and aircraft manufacturers are continuously devising new ways to improve customer experience and provide additional functionality of aircraft. Recently, a project has been proposed in which modules may be used to reconfigure the interior of an aircraft. For example, modules may be swapped in an out of the aircraft to provide different experiences such as a spa, a café or a gym depending on a desired configuration of the aircraft. However, in these proposals, an external form factor of the module corresponds substantially to that of the interior of the aircraft, for example to have the same external curvature as the inside of an aircraft cabin. This may cause problems with ground handling of modules because the modules may be bulky due to typical sizes of the aircraft for which they are intended to be used.

This may make handling of the modules at an aircraft stand of an airport difficult, because space at the aircraft stand may be limited, for example by layout of the airport. Furthermore, the size of the modules may mean that they are difficult to store and transport when not loaded into the aircraft. Typical airports may not have that much space that is dedicated for storage, and so substantial reconfiguration of airports might be needed for such modules to be adopted and handled efficiently.

Additionally, such modules may be limited to use with “cargo” style aircraft such as Airbus A330-220F, Boeing 737-700C or Boeing 777 Freighter or a standard aircraft without fit-out. Cargo style aircraft may typically have little or no interior fit out such as perimeter/side and/or ceiling fit-outs or compartments. Additionally, such aircraft typically do not have windows. Also, in the context of their use with modules, cargo doors corresponding to a cross section of the modules may typically be needed. As the proposed modules generally are prefabricated and correspond to the size of the aircraft, the doors may be large and costly to retrofit to existing aircraft. Additionally, since all the functionality and fit out generally has to be provided by the module, this may limit flexibility, and the lack of windows may lead to a less pleasurable passenger experience.

Examples of the present disclosure seek to address or at least alleviate the above problems.

In a first aspect, there is provided a cabin module deployable inside a vehicle so as to form at least a portion of an interior of the vehicle, the cabin module comprising: a main body; and a plurality of external walls, one or more of the plurality of external walls being moveable with respect to the main body; in which: the module has a closed configuration for storage outside the vehicle, in which the plurality of external walls define at least a part of a first form factor of the module; the module has an open configuration for operational deployment in the vehicle, in which the plurality of external walls define at least a part of a second form factor of the module; the cabin module is reversibly changeable between the closed configuration and the open configuration by movement of the one or more external walls; and the first form factor is different from the second form factor.

In second aspect, there is provided a vehicle comprising the cabin module of the first aspect. Other aspects and features are defined in the appended claims.

For example, an external form factor of the cabin module may be changed between a closed configuration and an open configuration, for example, to allow the cabin module to be moved from a ground side, where it is in the closed configuration, into the vehicle (such as an aircraft) where it may be deployed into the open configuration. For example, the open configuration has a different form factor than when in the closed configuration. This may help allow the cabin module to moved and stored more easily.

Furthermore, for example, the cabin module may be handled on the ground during loading or unloading onto the vehicle, or for storage or transport in the closed configuration. When in the open configuration, for example when operationally deployed in the vehicle, the cabin module may thus be used to provide different desired functionality, such as a restaurant, play area, gym, seating, bedding, or other functionality. Therefore, for example, the vehicle may be easily reconfigured by loading or unloading appropriate cabin modules, for example for each journey, depending on what may be desired for the vehicle at that time. Accordingly, a vehicle such as an aircraft may be given a more flexible layout with a shorter turn-around time, and with easier and more convenient handling of cabin modules.

### BRIEF DESCRIPTION

Examples of the disclosure will now be described by way of example only with reference to the accompanying drawings, in which like references refer to like parts, and in which:

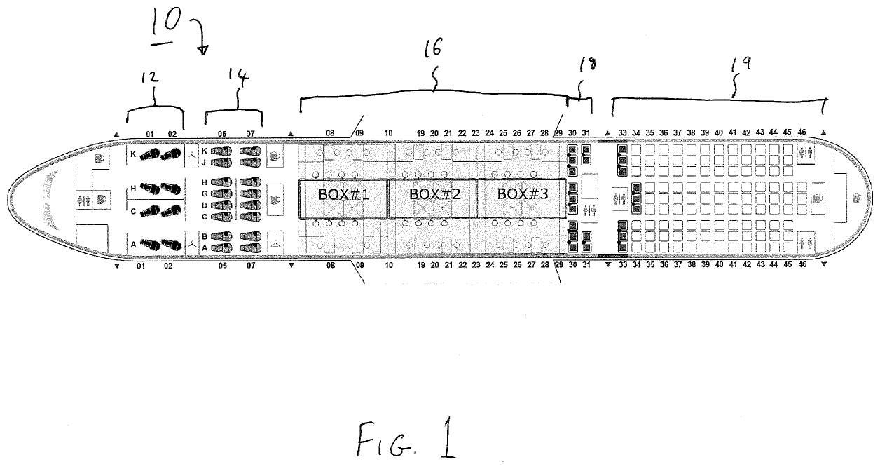

FIG. 1 is a schematic diagram of an interior plan of an aircraft according to examples of the disclosure;

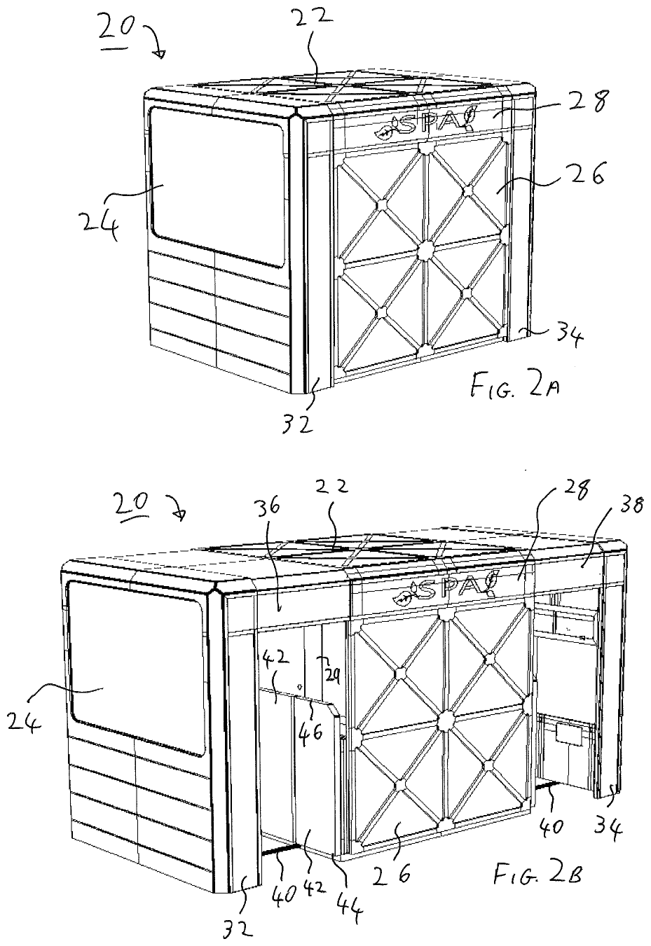

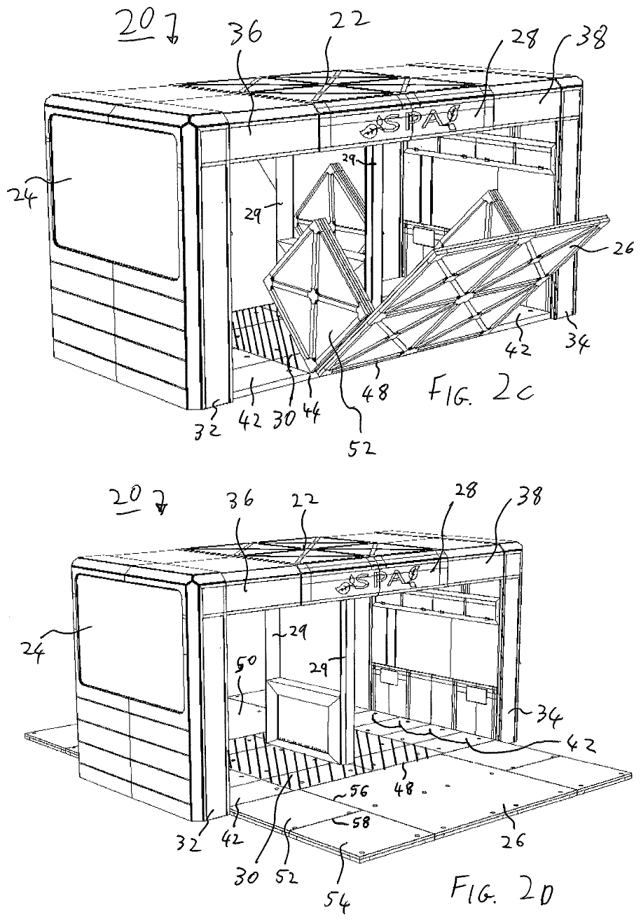

FIGS. 2A-2D schematically show deployment of a cabin module between a closed configuration and an open configuration according to examples of the disclosure;

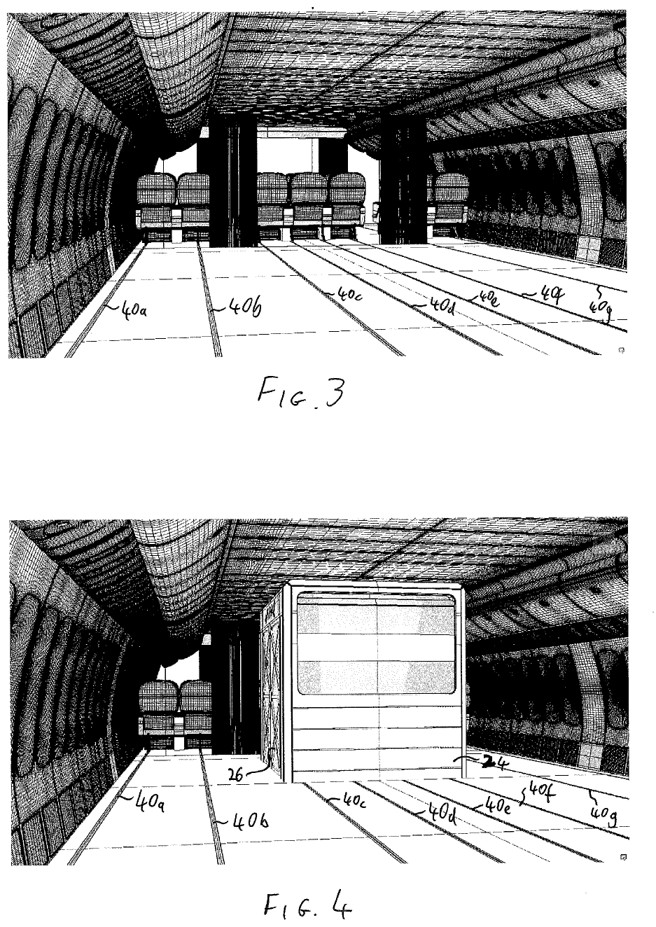

FIG. 3 is a schematic view of an interior of an aircraft in which the cabin module may be deployed according to examples of the disclosure;

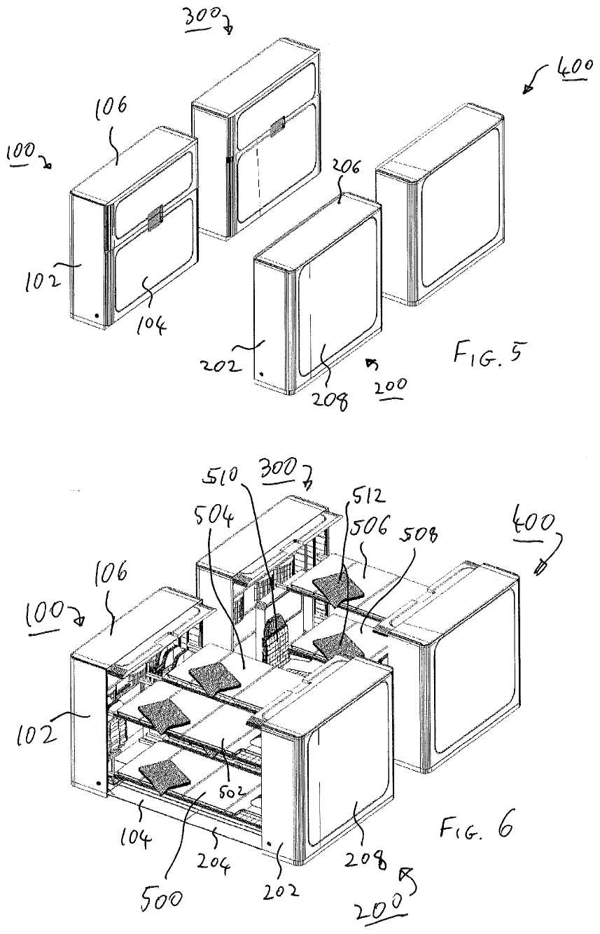

FIG. 4 is a schematic view of the interior of the aircraft in which the cabin module is shown in the closed configuration according to examples of the disclosure;

FIG. 5 is a schematic view of a plurality of multi-use cabin modules in a closed configuration according to examples of the disclosure;

FIG. 6 is a schematic view of the multi-use cabin modules in an open configuration corresponding to arrangement of the cabin modules for sleeping according to examples of the disclosure;

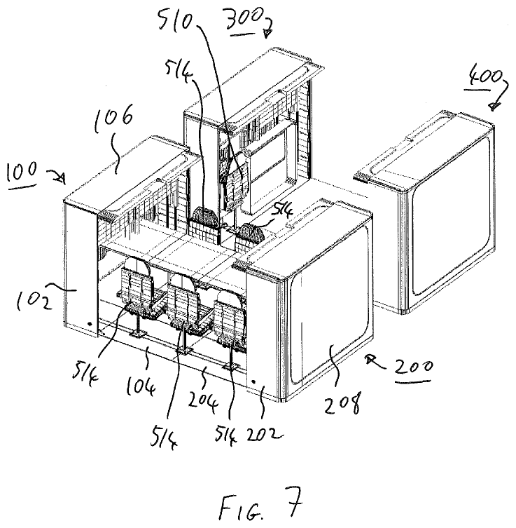

FIG. 7 is a schematic view of the multi-use cabin modules in an open configuration corresponding to arrangement of the cabin modules for seating at work desks according to examples of the disclosure;

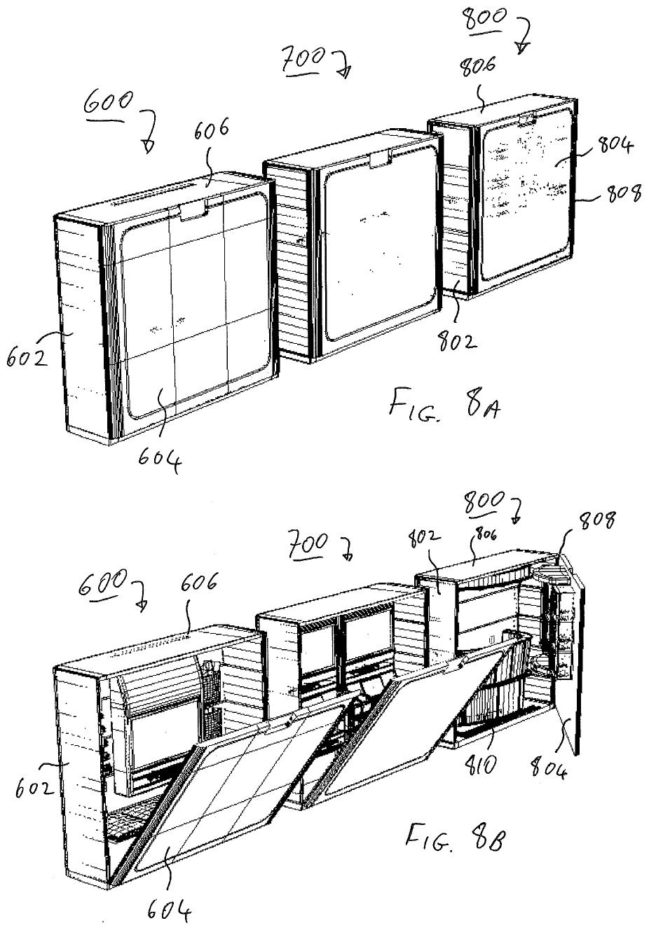

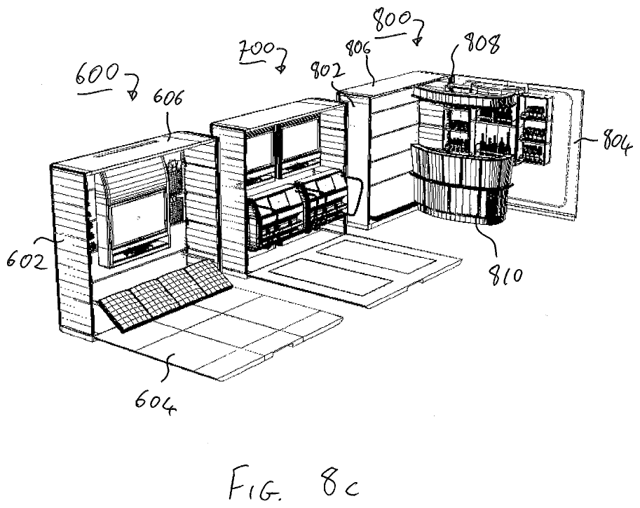

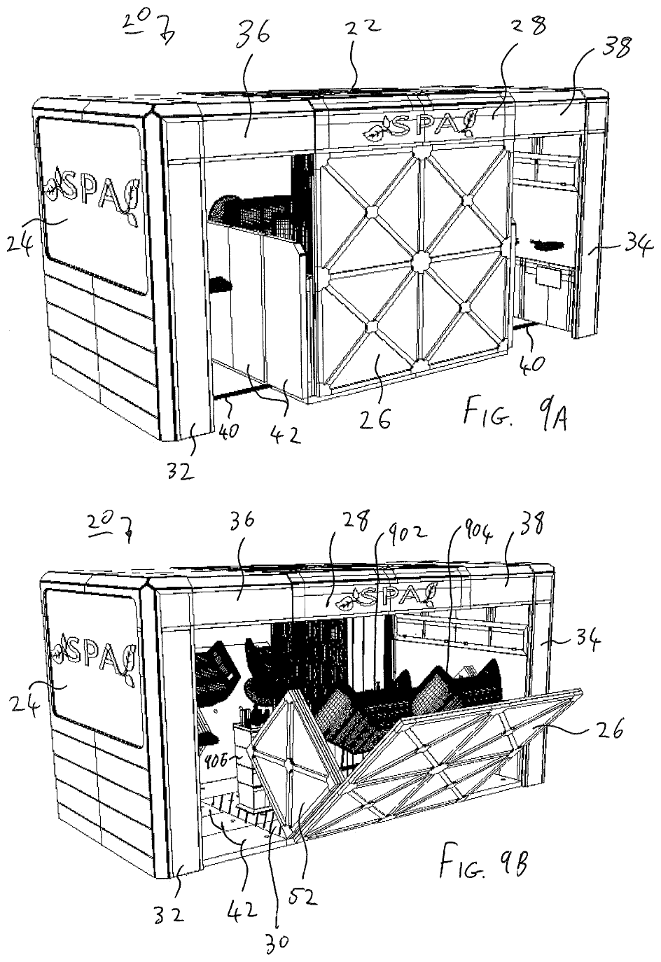

FIGS. 8A-8C schematically show a plurality of cabin modules that may be deployed inside other cabin modules according to examples of the disclosure; and

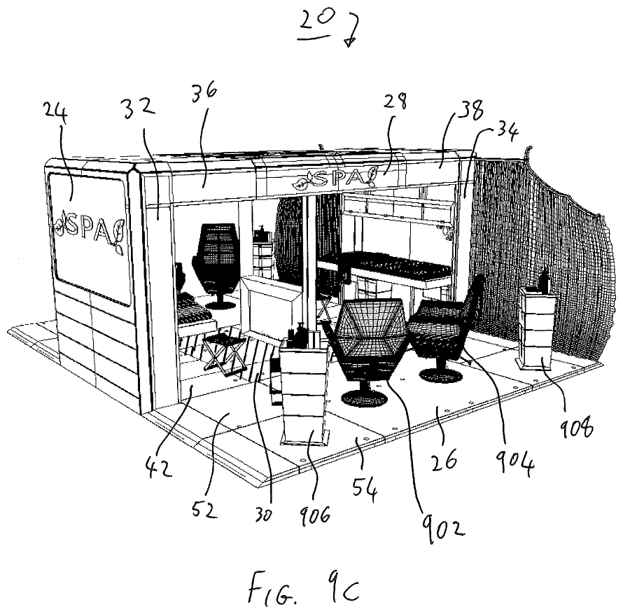

FIGS. 9A-9C schematically show deployment of a cabin module arranged as a spa facility according to examples of the disclosure.

### DETAILED DESCRIPTION

Examples of a cabin module and vehicle are disclosed. In the following description, a number of specific details are presented in order to provide a thorough understanding of the examples of the disclosure. It will be apparent however to a person skilled in the art that these specific details need not be employed in order to practise the examples of the disclosure. Conversely, specific details known to the person skilled in the art are omitted for the purposes of clarity in presenting the examples.

FIG. 1 is a schematic diagram of an interior plan of an aircraft according to examples of the disclosure. In particular, FIG. 1 shows an aircraft 10. In examples, the aircraft is arranged to be able to cooperate with one or more cabin modules that may be deployed inside the aircraft so as to form at least a portion of an interior of the aircraft 10.

In examples, the interior of the aircraft 10 is divided into zones, with each zone being associated with an interior function of the aircraft. In the example shown in FIG. 1, the aircraft 10 comprises a first class zone 12 (rows 01 and 02) in which first class amenities may be located, a business class zone 14 (rows 06 and 07) in which business class amenities such as business class seating may be found, a configurable zone 16 (rows 08-29) which may be configured to be able to provide different amenities or functionality by suitable positioning of one or more cabin modules within the configurable zone 16, a premium economy zone 18 (rows 30-31) in which premium economy class seating may be found, and an economy zone 19 (rows 33-46) in which economy class seating may be found. In the example shown in FIG. 1, Box #1, Box #2 and Box #3 indicate possible positions of cabin modules within the configurable zone 16. In examples, the configurable zone 16 may comprise one or more cabin modules which provide functionality such as one or more of seating, resting, a restaurant, a bar, a spa, or a play area for example although other functionality could of course be provided. The configurable zone 16 may encompass a whole or a part of a cabin space of the interior of the aircraft 10, for example depending on design requirements.

In examples, an external form factor of the cabin module may be changed between a closed configuration and an open configuration, for example, to allow the cabin module to be moved from a ground side where it is in the closed configuration into the aircraft where it may be deployed into the open configuration, for example where the open configuration has a larger form factor than when in the closed configuration. This may help allow the cabin module to moved and stored more easily. In other words, for example, the closed configuration may be thought of as a “not-in-use” configuration, and the open configuration may be thought of as an “in-use” configuration.

This functionality will now be described in more detail with reference to FIGS. 2A-2D. FIGS. 2A-2D schematically show deployment of a cabin module from a closed configuration to an open configuration according to examples of the disclosure. In particular, FIGS. 2A-2D show an example of a cabin module 20. In examples, the cabin module 20 is deployable inside a vehicle, such as the aircraft 10, so as to form at least a portion of an interior of the vehicle. In the example shown in FIGS. 2A to 2D, for ease of understanding the drawings, the cabin module 20 is shown in skeleton form without features such as chairs, beds, tables or other components or furniture that may be associated with a desired functionality of the module. However, more generally for example, cabin modules of examples of the disclosure could be configured as one or more of a gym, a spa, a bar, a games area, a seating area, and a sleeping area, or one or more portions thereof, although other configurations or arrangements are possible as well.

FIG. 2A schematically shows the cabin module 20 in a closed configuration. In examples, the closed configuration may be such that the cabin module 20 may be stored outside the aircraft 10, for example at a suitable storage facility located at an airport or off-site facility. In examples, the cabin module 20 comprises a main body 22 and a plurality of external walls, such as first external wall 24 and second external wall 26. In examples, the module 20 has a closed configuration as shown in FIG. 2A, in which the plurality of external walls define at least a part of a first form factor of the module 20. In examples, the cabin module 20 comprises a ceiling portion 28 and a floor portion 30. In examples, the main body 22 comprises the ceiling portion 28 and the floor portion 30, although it will be appreciated that either of the ceiling portion or the floor portion or both may be omitted or arranged differently as appropriate. In examples, the main body 22 comprises a pair of support columns 29 arranged to mechanically couple the ceiling portion 28 to the floor portion 30 so as to support the ceiling portion 28.

In examples, the external walls are arranged to be substantially rectilinear with each other for example such that an exterior of the cabin module 20 in the closed configuration, for example corresponding to the first form factor, is substantially cubical. However, it will be appreciated that other arrangements of the external walls are possible and that they could be curved or other suitable shapes. In examples, the plurality of external walls comprise a moveable wall which is moveable with respect to the main body 22. In examples, the first external wall 24 is a moveable wall which may be moved with respect to the main body 22, although it will be appreciated that one or more of the other external walls may be moveable as well or instead. In other words, in examples, one or more of the plurality of external walls are moveable with respect to the main body 22. In examples, one or more of the ceiling portion 28 and floor portion 30 may also be moveable, and thus may also be considered to be external walls. In other words for example, the term external wall could be considered to include any portion of the cabin module such as, wall, ceiling, floor, base or otherwise of the cabin module that forms an exterior of the cabin module, for example when it is in the closed configuration.

In examples, the module 20 has an open configuration for operational deployment in the vehicle, such as the aircraft 10. The open configuration is schematically illustrated in the example shown in FIG. 2D. FIGS. 2B and 2C show examples of intermediate positions of the external walls, for example when the module is transitioning between the closed and open configurations. In the open configuration of examples, the plurality of external walls define at least a part of a second form factor of the module. In examples, the first external wall 24 is reversibly moveable between the closed configuration and the open configuration. In examples, the first form factor is different from the second form factor. More generally, in examples, the cabin module 20 is reversibly changeable between the closed configuration and the open configuration by movement of the one or more external walls.

Therefore, for example, the closed configuration of the cabin module 20 may allow the cabin module to be more easily transported and stored, for example at the airport before being deployed in the aircraft 10 to the open configuration so as to provide desired functionality in the aircraft 10.

Within the context of examples of the disclosure, the term form factor for example means a shape and/or size of the cabin module, for example corresponding to an envelope defined by the external walls of the cabin module. However, it will, for example, be appreciated that the form factor of the cabin module generally relates to one or more of shape, size, configuration, and layout of the cabin module.

In examples, the cabin module comprises a first slidable portion 32 and a second slidable portion 34. In examples, the first slidable portion 32 comprises the first external wall 24, and the second slidable portion 34 comprises a third external wall (not shown). In examples, the first slidable portion 32 and the second slidable portion 34 may be moved with respect to the main body 22 by sliding with respect to the main body 22.

In examples, the first slidable portion 32 comprises a first sliding coupling portion 36 which is arranged to be able to cooperate with the ceiling portion 28 so as to be able to slide within the ceiling portion 28 and be guided by the ceiling portion 28.

In examples, the second slidable portion 34 comprises a second sliding coupling portion 38 which is arranged to be able to cooperate with the ceiling portion 28 so as to be able to slide within the ceiling portion 28 and be guided by the ceiling portion 28.

In examples, the aircraft comprises a guide rail 40, for example formed as a recess in the floor of the aircraft cabin. In examples, the first slidable portion 32 and the second slidable portion 34 are arranged to be able to cooperate with the guide rail 40 so as to able to be guided along the guide rail 40 when sliding. However, it will be appreciated that other suitable arrangements could be used.

Referring to FIGS. 2A and 2B, in examples, the first slidable portion 32 and the second slidable portion 34 are arranged to be able to reversibly move with respect to the main body 22 between a first position (shown in FIG. 2A) which corresponds to the closed configuration and a second position (shown in FIG. 2B) corresponding to their position in the open configuration. In examples, the cabin module 20 comprises one or more linear actuators operable to be able to move the first slidable portion 32 and the second slidable portion 34 with respect to the main body 22. In examples, the linear actuators are housed within the ceiling portion 28, although it will be appreciated that other arrangements are possible depending on design requirements. In examples, the linear actuators are electromechanically operated although it will be appreciated that pneumatic operation, hydraulic operation or other suitable arrangement could be used.

In examples, the first slidable portion 32 and the second slidable portion 34 are arranged to be able to slide with respect to the main body 22 at substantially the same time and same speed as each other. In other words, in examples, the first slidable portion 32 and the second slidable portion 34 may be deployed substantially symmetrically with respect to the main body 22. However, it will be appreciated that that could be moved at different times to each other and at different speeds when moving between the first position and the second position. Additionally, for example, the first slidable portion 32, the second slidable portion 34, or both could be omitted and replaced with a fixed external wall for example.

In examples, the cabin module comprises a plurality of hinged main floor panels such as hinged main floor panels 42. In examples, the hinged main floor panels 42 are substantially planar, and pivotably coupled to the floor portion 30 at an edge 44 so as to be able to pivot with respect to the floor portion 30 about the edge 44. In examples, the hinged main floor panels 42 are pivotably coupled to the floor portion 30 by a hinge at the edge 44, although it will be appreciated that other arrangements could be used, such as a flexible coupling.

Referring to FIGS. 2B and 2C for example, in the closed configuration, the hinged main floor panels 42 are arranged to be in a first main floor panel position. In examples, the first main floor panel position is substantially vertical position (as shown in FIG. 2B), although it will be appreciated that other suitable positions or orientations could be used. In examples, after the first slidable portion 32 and the second slidable portion 34 have moved from the first position (shown in FIG. 2A) to the second position (shown in FIG. 2B), the hinged main floor panels 42 are arranged to be able to move from the first main floor panel position to a second main floor panel position, for example so as to from a part of a floor of the cabin module when the cabin module is in the open configuration. In examples, the second main floor panel position is a substantially horizontal position (shown in FIG. 2C) although it will be appreciated that other positions or orientations could be used, In other words, for example, the hinged main floor panels 42 may be in a substantially horizontal arrangement when the cabin module is in the open configuration.

In examples, an outer edge 46 of the hinged main floor panels 42 which is located away from the edge 44 is arranged to be able to engage with the first slidable portion 32 (or second slidable portion 34 as appropriate) when the cabin module is in the open configuration and the main floor panels are in the horizontal position. In examples, the cabin module 20 comprises a main floor panel locking mechanism operable to lock the outer edge 46 to the first slidable portion 32 when the cabin module 20 is in the open configuration. This may help provide rigidity to the cabin module as well as providing an extra level of safety against accidental movement, for example when the aircraft 10 is moving.

In examples, the cabin module 20 comprises a main floor panel actuating mechanism arranged to be able to move the main floor panels (such as main floor panels 42) with respect to the floor portion 30. In examples, the main floor panel actuating mechanism comprises one or more actuators such as pneumatic, electromechanical or hydraulic actuators arranged to be able to pivot the main floor panels with respect to the floor portion 30. In examples, the main floor panel actuating mechanism is located between adjacent edges of the main floor panels so as to lie flat with the main floor panels when they are in the second main floor panel position such as a horizontal position. However, it will be appreciated that other suitable arrangements could be used.

In examples, the external wall 26 is a moveable substantially planar wall which is moveable with respect to the main body 22. Referring to FIGS. 2A and 2B, in examples, when the cabin module 20 is in the closed configuration, the substantially planar wall (external wall 26) is arranged to be in first planar wall position such as a substantially vertical position, although other positions or orientations are possible. In examples, in the open configuration, the substantially planar wall is arranged to be in a second planar wall position such as a substantially horizontal position so as to form a floor of the module, for example as shown in FIG. 2D, although it will be appreciated that other suitable positions or orientations could be employed. FIG. 2C schematically shows an example of an intermediate position of the external wall 26, for example during movement from the closed configuration to the open configuration or vice versa.

In examples, the external wall 26 is pivotable (rotatable) about a first edge 48 of the external wall 26 with respect to the main body 22. In particular, in examples, the external wall 26 is pivotably coupled to the floor portion 30 at the first edge 48. In examples, the cabin module 20 comprises a hinge located at the edge 48 arranged to allow the external wall 26 to pivot with respect to the floor portion 30 about the hinge. In other words for example, one or more of the external walls may be foldable with respect to the main body 22. A similar actuating mechanism to that used to deploy the main floor panels 42 may be used to move the external wall 26, although it will be appreciated that this could be different depending on design requirements.

In examples, the cabin module 20 comprises a plurality of side floor panels such as a first side floor panel 52 and a second side floor panel 54. In examples, the side floor panels are substantially planar. In examples, the first side floor panel 52 is pivotably coupled to the external wall 26 at an edge 56 of the first side floor panel 52 located between the first side floor panel 52 and the external wall 26 so as to be able to pivot or hinge about the edge 56. In examples, when the cabin module 20 is in the closed configuration, the first side floor panel 52 is arranged to be substantially co-planar with the second side floor panel 54.

In examples, the second side floor panel 54 is pivotably coupled to the first side floor panel 52 at an edge 58 of the second side floor panel 54 located between the second side floor panel 54 and the first side floor panel 52 so as to be able to pivot or hinge about the edge 58. This arrangement may help reduce a likelihood that the side floor panels may snag or contact the roof portion 28 when the external wall 26 is moved between the vertical position and the horizontal position, for example.

In examples, the side floor panels are in first side floor panel position such as that having a substantially vertical orientation when the cabin module 20 is in the closed configuration and a second side floor panel position such as one having a substantially horizontal orientation when the cabin module 20 is in the open configuration for example so as to be able to form a floor when the cabin module is in the open configuration. A similar actuating mechanism to that used to deploy or move the main floor panels 42 may be used to move the side floor panels, although it will be appreciated that the actuating mechanism could be different. In examples, a similar arrangement to that of the external wall 26 and its corresponding side floor panels may employed for an external wall 50 on an opposite side of the cabin module 20 to the external wall 26. Additionally, in examples, the arrangement of the side floor panels with respect to the external wall 26 and the external wall 50 is substantially the same for each corner of the cabin module 20, although it will be appreciated that this could vary depending on design requirements.

A deployment sequence for deploying the cabin module 20 from the closed configuration to the open configuration will now be described with reference to FIGS. 2A to 2D.

As mentioned above, FIG. 2A shows an example of the cabin module 20 in the closed configuration. In examples, the cabin module 20 has a first footprint which corresponds to an area defined by the perimeter of the external walls at a base of the cabin module for example.

From the closed configuration, in examples, the first slidable portion 32 and the second slidable portion may be caused to slide with respect to the main body 22 from the first position to the second position (for example as shown in FIG. 2B). The main floor panels, such as the main floor panels 42 may then be moved with respect to the floor portion 30 from the vertical position (shown in FIG. 2B) to the horizontal position (shown in FIG. 2C) so as to form a part of the floor of the cabin module in the open configuration. Proceeding from FIG. 2B to FIG. 2D via FIG. 2C, in examples, the external wall 26 and the external wall 50 may be caused to pivot with respect to the floor portion 30 so as to move from the vertical position (shown in FIGS. 2A and 2B) to the horizontal position (shown in FIG. 2D). In examples, once the external wall 26 is in the horizontal position, for example so as to form part of the floor of the cabin module 20 in the open configuration, the side floor panels may be moved to the horizontal position.

Referring to FIG. 2D for example, once the external wall 26 is in the horizontal position (as shown in FIG. 2D), the first side floor panel 52 and the second side floor panel 54 are caused to pivot 90 degrees with respect to the external wall 26 about the edge 56 of the first side floor panel 52 until they are both in the horizontal position. In examples, the second side floor panel 54 is then caused to pivot 180 degrees with respect to the first side floor panel 52 about the edge 58 so that the second side floor panel 54 lies adjacent to the first side floor panel 52 and the external wall 26. A similar procedure may be followed for deployment of the other side floor panels.

In examples, the cabin module may be caused to move from the open configuration to the closed configuration (retraction) by reversing the deployment sequence described above, although it will be appreciated that operations of the sequence may be performed in other suitable orders.

In examples, movement and deployment of the external walls 26 and 50 may occur substantially at the same time as movement of the main floor panels such as the main floor panels 42. However, it will be appreciated that this could happen at different times, for example sequentially. Additionally, it will be appreciated that moveable features of the cabin module 20 such as the slidable portions, external walls, main floor panels, and side floor panels, may be moved or deployed in any suitable order from the closed configuration to the open configuration or from the open configuration to the closed configuration. In other words, more generally in examples, one or more elements of the cabin module may be moveable and/or foldable with respect to each other so as to allow the form factor of the cabin module 20 to be changed between the closed configuration and the open configuration.

In examples, the cabin module 20 has a second foot print in the open configuration. In examples. the second foot print corresponds to an area defined by the perimeter of base of the cabin module such as that corresponding to the side floor panels, slidable portions, external walls, main floor panels, for example where the cabin module is in contact with a surface on which is it placed, such as the cabin floor of the aircraft. In other words, in examples, a footprint of the cabin module in the open configuration is bigger than a footprint of the cabin module in the closed configuration, for example as illustrated by comparison between FIGS. 2A and 2D.

In examples, the first form factor defines a first volume, and the second form factor defines a second volume. For example, referring to FIG. 2A, the external walls, the ceiling portion 28 and the floor portion 30 correspond to the first form factor and define the first volume, for example, the volume of cabin as based on exterior surfaces of the cabin module 20. In examples, the second volume is larger than the first volume. In examples, the first volume is a substantially closed volume and the second volume is a substantially open volume. For example, the open volume may be taken for example to mean that access to an interior of the cabin module may be obtained, whereas a closed volume, may for example relate to the closed configuration, where for example, an interior of the cabin module may be protected or shielded by the exterior of the cabin module as provided by exterior surfaces or walls for example from ingress to the interior.

An example of deployment of a cabin module such as the cabin module 20 in the aircraft 10 will now be described with reference to FIGS. 3 and 4. FIG. 3 is a schematic view of an interior of an aircraft in which the cabin module may be deployed according to examples of the disclosure, and FIG. 4 is a schematic view of the interior of the aircraft in which the cabin module is shown in the closed configuration according to examples of the disclosure. In examples, a plurality of recessed guide rails 40a-40f are formed in the floor of the aircraft 10, such as those similar to the guide rail 40 described above.

In order to load one or more cabin modules onto the aircraft 10, a manual or automated process such as that used for handling cargo containers may be used. In order to assist ease of handling, the cabin modules may be moved while in the closed configuration. This may also help protect the interior of the cabin modules from environmental hazards such as water soiling from inclement weather conditions. Additionally, since in examples, the form factor in the closed configuration is smaller than the form factor in the open configuration, the cabin modules may be handled and maneuvered more easily. Furthermore, for example, doors, such as cargo doors, required for loading or unloading of the modules onto or off the aircraft may be made smaller and simpler. Some existing fit out, such as windows, and side overhead lockers may also be more likely to be able to be retained if existing aircraft (e.g. so-called wide body aircraft) are to be retrofitted to be able to operate with one or more cabin modules of the examples of the disclosure. In examples, one or more cargo doors may be retrofitted to existing aircraft or modified as appropriate to accommodate loading and unloading of cabin modules, for example depending on design requirements.

In examples, the cabin module 20 comprises a safety lock mechanism arranged to be able to secure the cabin module 20 in the closed configuration. More generally, in examples, the cabin module 20 comprises a locking mechanism having a locked position and an unlocked position, in which the locking mechanism is moveable between the locked position and the unlocked position. In examples, the locking mechanism is arranged to be able to hold the module in the closed configuration when the locking mechanism is in the locked position. The locking mechanism (safety lock mechanism) may help prevent accidental deployment or movement of the external walls, for example when the cabin module 20 is being loaded onto the aircraft. In examples, one or more of the external walls are able to move between the closed configuration and the open configuration when the locking mechanism is in the unlocked position.

In examples the locking mechanism is arranged to be able to hold the cabin module 20 in the open configuration when the locking mechanism is in the locked position. In examples, the locking mechanism is able to cooperate with at least a portion of the aircraft so as to be able to hold the cabin module in the open configuration. For example, the external walls or slidable portions may be locked to the guide rails by the locking mechanism.

In examples, the cabin module 20 comprises a plurality of wheels or rollers so as to allow the cabin module 20 to be moved around, for example, with respect to the aircraft or when on the ground. In examples, the cabin module(s) are moved to a desired position where they may be deployed from the closed configuration to the open configuration, for example, according to the deployment sequence described above with reference to FIGS. 2A to 2D.

In examples, the cabin module 20 comprises a plurality of cabin module sensors such as position sensors, that allow the relative position of elements of the cabin module to be detected. In examples, the cabin module 20 comprises a control unit operable to communicate with the cabin module sensors. For example, the control unit is operable to determine whether the cabin module is in the closed configuration, open configuration, or intermediate position based on information from the cabin module sensors. Additionally, in examples, the control unit is operable to control movement of the cabin module between the closed and open configurations.

In examples, the control unit comprises a relative position sensor operable to detect a relative position of the cabin module with respect to the aircraft. In examples, the relative position sensor comprises a RFID (radio frequency identification) sensor although it will be appreciated that other location sensors such as radio frequency triangulation, laser or sonic positioning, or computer vision and image processing sensors could be used. This may for example allow the control unit to determine if the cabin module is located at a desired position.

When the cabin modules are at a desired location, for example as determined by the control unit, they may be connected to a power supply from the aircraft, and other systems such as entertainment networks, and safety systems such as oxygen supply. In examples, this may be accomplished automatically via a suitable automated system. In other examples, the cabin modules may be connected manually.

Additionally, in examples, when the cabin module 20 detects that it is at a desired or required position (for example as illustrated in FIG. 4), the control unit is operable to cause the cabin module to lock itself in position, for example via a suitable interlock mechanism which engages with the guide rails 40.

In examples, the control unit is operable to cause the safety lock mechanism to disengage in response to an unlock signal received from a ground handling system or input by a user such as a member of ground staff so as to allow the cabin module to move from the closed configuration to the open configuration. In examples, the control unit may then cause the cabin module to deploy from the closed configuration to the open configuration.

Once the cabin module has been deployed to the open configuration, in examples, the control unit is operable to generate and output a ready-to-use signal which may be transmitted to a ground handling system and displayed visually on the cabin module, for example. In examples, the ready-to-use signal indicates that cabin module 20 is deployed in the open configuration and ready to use.

In examples, offloading of cabin modules reverses the sequence mentioned above for example by retracting the moveable components of the cabin module. In examples, the cabin module sensors are operable to detect force loads experienced by one or more components of the cabin module, for example in relation to movement of one or more components with respect to other components. If, for example, it is detected that a load force exceeds a threshold load, then movement of a cabin module component or components (such as external walls, slidable portions, or floor panels for example) associated with that force load may be halted. This may help prevent damage to the component or components.

If more than one cabin module is to be used in the aircraft, then a similar procedure may be used for each cabin module. Additionally, the cabin modules may be deployed at substantially the same time as each other or at different times, depending on operational requirements. In examples, the control unit is operable to control an order and timing in which elements and components of the cabin module are deployed or retracted. However, it will also be appreciated that the order in which various components are deployed or retracted may also depend on their mechanical configuration.

In examples, as mentioned above, cabin modules of examples of the disclosure may be configured to have different functionalities. In examples, multi-use cabin modules may be used, for example in cooperation with a cabin module such as cabin module 20 or as stand-alone cabin modules. In examples, multi-use cabin modules may be arranged to be reversibly changeable between a closed configuration and an open configuration by movement of one or more external walls. In examples, the open configuration and the closed configuration of the multi-use cabin modules are defined in substantially the same way as for the cabin module 20 described above.

Multi-use cabin modules according to examples of the disclosure will now be described with reference to FIGS. 5 to 7. FIG. 5 is a schematic view of a plurality of multi-use cabin modules in a closed configuration according to examples of the disclosure. FIG. 6 is a schematic view of the multi-use cabin modules in an open configuration corresponding to arrangement of the cabin modules for sleeping according to examples of the disclosure. FIG. 7 is a schematic view of the multi-use cabin modules in an open configuration corresponding to arrangement of the cabin modules for seating at work desks according to examples of the disclosure.

In particular, FIG. 5 schematically shows a plurality of multi-use cabin comprising a first multi-use cabin 100, a second multi-use cabin 200, a third multi-use cabin 300, and a fourth multi-use cabin 400. In examples, cabin module 100, cabin module 200, cabin module 300 and cabin module 400 are substantially the same as each other. However, it will be appreciated that one or more of them could be different from each other.

In examples, the cabin module 100 is arranged with respect to the cabin module 200 so they may cooperate together to provide desired cabin functionality. In examples, cabin modules 300 and 400 are arranged in a similar manner to cabin modules 100 and 200. In examples, the cabin module 100 comprises a plurality of external walls such as external wall 102 and external wall 104. In examples, the external walls of the cabin module 100 are substantially planar, although it will be appreciated that other shapes and arrangements could be used.

In examples, the cabin module 100 comprises a ceiling portion 106 which forms a roof or ceiling of the cabin module 100. In examples, the ceiling portion is coupled to a base of the cabin module via one or more external walls, or by an interior structure of the cabin module 100 which forms a main body of the cabin module 100. In examples, the external wall 104 is moveable with respect to the main body of the cabin module 100 such as the interior structure. In examples, the external wall 102 is a fixed external wall. In examples, the external wall 104 is pivotable about the base of the cabin module 100 so as to be able to move from a substantially vertical orientation when in the closed configuration (for example as shown in FIG. 5) to a substantially horizontal configuration when in the open configuration (for example as shown in FIG. 6). In examples, the arrangement of the external wall 104 with respect to the main body may be similar or substantially the same as that described above with reference to the external wall 26.

In examples, the cabin module 200 comprises a plurality of external walls such as external wall 202, external wall 204, and external wall 208. In examples, the external walls of the cabin module 200 are substantially planar, although it will be appreciated that other shapes and arrangements could be used.

In examples, the cabin module 200 comprises a ceiling portion 206 which forms a roof or ceiling of the cabin module 200. In examples, the ceiling portion is coupled to a base of the cabin module via one or more external walls, or by an interior structure of the cabin module 200 which forms a main body of the cabin module 200. In examples, the external wall 204 is moveable with respect to the main body of the cabin module 200 such as the interior structure. In examples, the external wall 202 and the external wall 208 are fixed external walls. In examples, the external wall 204 is pivotable about the base of the cabin module 200 so as to be able to move from a substantially vertical orientation when in the closed configuration (for example as shown in FIG. 5) to a substantially horizontal configuration when in the open configuration (for example as shown in FIG. 6). In example, the arrangement of the external wall 204 with respect to the main body may be similar or substantially the same as that described above with reference to the external wall 26.

In other words, more generally in examples, the plurality of external walls comprises a moveable substantially planar wall (such as the external wall 104 or the external wall 204) which is moveable with respect to the main body. In examples, in the closed configuration, the substantially planar wall is arranged to be in a first position such as substantially vertical position, and in the open configuration, the substantially planar wall is arranged to be in a second position such as substantially horizontal position so as to form at least a part of a floor of the module. More generally, in examples, the substantially planar wall is pivotable about an edge of the substantially planar wall with respect to the main body. Therefore, for example, a form factor of the multi-use cabin module in the closed configuration may be different from a form factor of the multi-use cabin module in the open configuration.

In examples, two or more cabin modules may cooperate together to provide desired functionality. For example, referring to FIG. 6, the cabin module 100 may cooperate with the cabin module 200 so as to provide a sleeping facility comprising a first bed 500, a second bed 502, and a third bed 504. In examples, while in the open configuration, one or more cabin modules may be reconfigured to provide a different functionality, for example by provision of suitable interior components. In the example shown in FIG. 6, the cabin module 300 is shown in cooperation with the cabin module 400 so as to provide a mixed sleeping and seating facility comprising a fourth bed 506, a fifth bed 508, a comfortable chair 510 and some soft cushions 512. In examples, the first bed 500 may be arranged below the second bed 502, and the fourth bed 506 arranged above the sixth bed 508. In examples, the beds (such as beds 500, 502, 504, 506, and 508) comprise one or more mattress support components which may be foldably stowed within the main body of the respective cabin modules, for example, when not required or when the cabin module(s) is in the closed configuration. In examples, the chair 510 may also be foldable within the main body of the cabin module 300, for example when not in use or when the cabin module 300 is in the closed configuration. The cushions 512 may be manually stowed by a flight attendant for example.

Referring to FIG. 7 for example, the first bed 500 and the third bed 504 are in a stowed position so that a plurality of office chairs such as chairs 514 may be positioned with respect to the mattress support components of the second bed 502 so that those mattress support components may be used as a table. In the example shown in FIG. 7, the mattress support components of the fourth bed 506 and the fifth bed 508 are stowed within the main bodies of the cabin module 300 and the cabin module 400 so as to be able to provide access to the chairs 514 located towards those modules. In the example of FIG. 7, the chair 510 is in a stowed position.

In other words, in examples, a cabin module may comprise furniture having a stowed position when the module is in the closed configuration, and a deployed position when the module is in the open configuration. In examples, the furniture is moveable between the stowed position and the deployed position in response to movement of one or more of the external walls. For example, the first bed 500 may be caused to deploy when the first multi-use module 100 and the second multi-use module 200 move from the closed configuration to the open position. More generally, in examples, the furniture is foldable and able to reversibly fold and unfold between the stowed position and the deployed position. In examples, the furniture is arranged to be able to reversibly fold and unfold between the stowed and deployed position in response to movement of one or more of the external walls.

As mentioned above, in examples, a cabin module may be deployed and/or retracted within one or more other cabin modules (e.g. a cabin-in-cabin arrangement) or may be used as standalone unit or in cooperation with other cabin modules.

FIGS. 8A-8C schematically show a plurality of cabin modules that may be deployed inside other cabin modules according to examples of the disclosure. In particular, FIG. 8A shows a plurality of cabin modules comprising cabin module 600, cabin module 700 and cabin module 800. In the example of FIG. 8A the cabin modules 600, 700, 800 are shown in the closed configuration. In the example shown in FIG. 8B, the cabin modules 600, 700, 800 are shown in an intermediate position between the closed configuration and the open configuration. In the example shown in FIG. 8C, the cabin modules 600, 700, 800 are shown in the open configuration.

In examples, the cabin modules 600, 700, 800 may be configured internally so they may be used as different functions such as a game zone, a bar, a fitness centre, a café, a business outlet or vending unit and the like when in the open configuration. In the examples of FIGS. 8A to 8C, the cabin module 600 is configured as an audiovisual entertainment system, for example for watching movies or TV programs, the cabin module 700 is configured as a game centre for example for playing of video games, and the cabin module 800 is configured as a bar or café. However, it will be appreciated that cabin modules of examples of the disclosure could have any appropriate functionality for example depending on user requirements or operator requirements.

For example, depending on the height of the cabin module(s) in the open configuration, some ceiling fit-out such as central overhead lockers may be retained if an aircraft is to be retrofitted for use with cabin modules of examples of the disclosure, although it will be appreciated that a degree of modification, fit-out or retrofit may depend on design requirements.

In examples, the cabin module 600 comprises a plurality of external walls such as external wall 602 and external wall 604. In examples, the external walls of the cabin module 600 are substantially planar, although it will be appreciated that other shapes and arrangements could be used.

In examples, the cabin module 600 comprises a ceiling portion 606 which forms a roof or ceiling of the cabin module 600. In examples, the ceiling portion is coupled to a base of the cabin module via one or more external walls, or by an interior structure of the cabin module 600 which forms a main body of the cabin module 600. In examples, the external wall 604 is moveable with respect to the main body of the cabin module 600 such as the interior structure. In examples, the external wall 602 is a fixed external wall. In examples, the external wall 604 is pivotable about the base of the cabin module 600 so as to be able to move from a first position such as substantially vertical orientation when in the closed configuration (for example as shown in FIG. 8A) to a second position such as a substantially horizontal configuration when in the open configuration (for example as shown in FIG. 8C). For example the external wall 604 is arranged to be able to be in second position (e.g. a substantially horizontal position) so as to form at least a part of a floor of the module 600 when in the open configuration. In examples, cabin module 700 has substantially the same arrangement of external walls as the cabin module 600, although it could be different.

In examples, the cabin module 800 comprises a plurality of external walls such as external wall 802 and external wall 804. In examples, the external walls of the cabin module 600 are substantially planar, although it will be appreciated that other shapes and arrangements could be used.

In examples, the cabin module 800 comprises a ceiling portion 806 which forms a roof or ceiling of the cabin module 800. In examples, the ceiling portion is coupled to a base of the cabin module via one or more external walls, or by an interior structure of the cabin module 800 which forms a main body of the cabin module 800. In examples, the external wall 804 is moveable with respect to the main body of the cabin module 800 such as the interior structure. In examples, the external wall 802 is a fixed external wall. In examples, the external wall 804 is pivotable about a vertical edge 808 of the cabin module 800 so as to be able to move from a first position such as a first substantially vertical position when in the closed configuration (for example as shown in FIG. 8A) to second position such as second substantially vertical position when in the open configuration (for example as shown in FIG. 8C) in which first position of the external wall 804 in the closed configuration is different from the second position of the external wall 804 in the open configuration. In other words, for example, the external wall 804 may act like a door in the example of the cabin module 800.

More generally in examples, the form factors of the cabin modules 600, 700, 800 when in the closed configuration are different from the respective form factors of the cabin modules 600, 700, 800 when in the open configuration.

In examples, the cabin module comprises a bar counter 810. In the example shown in FIG. 8B, the bar counter 801 is shown in a stowed position within the cabin module 800 which corresponds to its position when the cabin module is in the closed configuration. In the example of FIG. 8C, the bar counter 810 is shown in a deployed position which corresponds to the open configuration. In examples, the bar counter 810 is moveable form the stowed position to the deployed position in response to movement of the external wall 804, for example via mechanical linkages or in response to a deployment actuating signal generated by the control unit when the external wall 804 is at the second vertical position corresponding to the open configuration. In examples, the bar counter 810 may be arranged to be able to slide from the stowed position to the deployed position, for example using suitable furniture guiding rails, or on rollers or wheels for example More generally, in examples, the cabin modules comprise furniture arranged to be slideable with respect to the module between the stowed position and the deployed position in response to movement of one or more of the external walls. In examples, furniture may comprise, one or more of: table, chair, stool, sofa, seat, gym equipment, bar furniture, bed, desk, audio equipment, audio visual equipment, computer equipment, and the like, although it will be appreciated that any suitable furniture could be used.

In examples, one or more of the cabin modules 600, 700, and 800 may be deployed inside another cabin module such as the cabin module 20, or in cooperation with one or more other cabin modules such as cabin modules 100, 200, 300, and 400. However, it will be appreciated that the cabin modules of the examples of FIGS. 8A-8C could also be used as standalone units for example depending on design requirements. In examples, deployment and retraction of one or more of the cabin modules 100, 200, 300, 400, 600, 700, 800 inside a vehicle such as the aircraft 10 may be performed in a similar manner as that described above with reference to FIGS. 4 and 5, for example, although it will be appreciated that other suitable techniques could be used. Additionally, in examples, deployment and retraction of components of one or more of the cabin modules 100, 200, 300, 400, 600, 700, 800 such as furniture, external walls or other moveable components may be performed using one or more actuating mechanisms such as those described above with reference to FIGS. 2A-2D and the cabin module 20.

FIGS. 9A-9C schematically show deployment of a cabin module arranged as a spa facility according to examples of the disclosure. In particular FIGS. 9A-9C schematically show an example of the cabin module 20 arranged as a spa or wellness facility.

In examples, the closed configuration substantially corresponds to that described above with respect to FIG. 2A above. FIGS. 9A and 9B schematically show examples of intermediate arrangements of the cabin module 20 between the closed configuration and the open configuration. FIG. 9C schematically shows an example of the open configuration.

In the example of FIGS. 9A-9C, the cabin module 20 comprises furniture such as a plurality of furniture items corresponding to those which may typically be found in a spa or wellness centre for example. In examples, furniture is in a stowed position within the form factor of the cabin module 20 when in the closed configuration. On deployment of the cabin module 20 from the closed configuration to the open configuration, the furniture may be caused to move from the stowed position to one or more deployed positions. In examples, the furniture may move from the stowed position to the deployed position in response to movement by one or more of the external walls such as external wall 24 or external wall 26.

In examples, the cabin module 20 comprises a plurality of chairs such as chair 902 and chair 904. In examples, the chair 902 and the chair 904 are mounted to the external wall 26 so as to be moveable with the external wall 26. In other words, for example, chairs 902 and 904 may move with the external wall 26 from a stowed position where the external wall 26 is substantially vertical to a deployed position (for example as shown in FIG. 9C) where the external wall 26 is substantially horizontal so as to form a portion of the floor of the cabin module 20. In other examples, the chairs 902 may rest on the floor portion 30 when in the stowed position and be moved or slid to the deployed position when the cabin module is deployed to the open configuration for example in response to movement by one or more external walls.

In examples, the cabin module 20 comprises one or more spa cabinets such as a first spa cabinet 906 and a second spa cabinet 908. In examples, a stowed position of the spa cabinets 906 and 908 (for example as shown in FIG. 9B) when the cabin module is in the closed configuration is so that they are resting on the floor portion 30, for example as held by a safety locking mechanism. In examples, the spa cabinets 906 and 908 are slidable with respect to the cabin module 20 between the stowed position and a deployed position (as shown for example in FIG. 9C) in response to movement of one or more of the external walls such as the external wall 26. In examples, the spa cabinets may be moved between the stowed position and the deployed position manually, for example by ground or cabin staff. However, in other examples, they may be caused to move automatically between the stowed position and the deployed position using suitable driving means along suitable multifunction guiderails formed in the floor of the cabin module when in the open configuration such as one or more of the floor panels 42, the external wall 26, the floor portion 30, the slide floor panel 52 and the slide floor panel 54.

Although the cabin module shown in the example of FIGS. 9A to 9C has been described as being arranged as a spa, it will be appreciated that it could be arranged as any suitable function with appropriate furniture and functionality as desired.

Although in the above examples cabin modules have been described with reference to an aircraft, it will be appreciated that use of one or more cabin modules of examples of the disclosure is also possible with other types of vehicle or transport vessel for example, such as trains, buses, boats, spaceships or space craft, helicopters, drones, or other vehicles. In examples, the cabin modules described herein are passenger cabin modules, for example, for use by one or more passengers of the vehicle. However, it will be appreciated that they could be configured as cargo modules with changes as appropriate. In examples, the form factor of a cabin module in the closed configuration may be a substantially rectangular prism such as a rectangular cuboid or box shape so as to be able to provide easy stacking and storage for example, although it will be appreciated that any other appropriate shapes could be used depending on design requirements.

Some examples described above have been described in terms of horizontal and vertical orientations of features such as the external walls. However, it should be appreciated that these may be taken as relative terms, for example such that on rotation of a cabin module(s) or a different overall orientation of the module(s), a same relative relationship may apply between those features. Additionally, it will be appreciated that the relative positions as defined by the terms horizontal and vertical for example, could be different from each other depending on design requirements for example, and the relative relationship between components described as having a vertical or horizontal position or orientation may have other appropriate angular or relative relationships with each other for example.

Although a variety of examples have been described herein, these are provided by way of example only and many variations and modifications on such examples will be apparent to the skilled person and fall within the spirit and scope of the present invention, which is defined by the appended claims and their equivalents.

1. A cabin module deployable inside a vehicle so as to form at least a portion of an interior of the vehicle, the cabin module comprising:
a main body; and
a plurality of external walls, one or more of the plurality of external walls being moveable with respect to the main body;
in which:
the module has a closed configuration for storage outside the vehicle, in which the plurality of external walls define at least a part of a first form factor of the module;
the module has an open configuration for operational deployment in the vehicle, in which the plurality of external walls define at least a part of a second form factor of the module;
the cabin module is reversibly changeable between the closed configuration and the open configuration by movement of the one or more external walls; and
the first form factor is different from the second form factor.

2. A cabin module according to claim 1, in which:
the first form factor defines a first volume;
the second form factor defines a second volume; and
the second volume is larger than the first volume.

3. A cabin module according to claim 2, in which the first volume is a substantially closed volume and the second volume is a substantially open volume.

4. A cabin module according to claim 1, in which a footprint of the cabin module in the open configuration is bigger than a footprint of the cabin module in the closed configuration.

5. A cabin module according to claim 1, in which:
the plurality of external walls comprises a moveable substantially planar wall which is moveable with respect to the main body;
in the closed configuration, the substantially planar wall is arranged to be in a first position; and
in the open configuration, the substantially planar wall is arranged to be in a second position so as to form at least part of a floor of the module.

6. A cabin module according to claim 5, in which the substantially planar wall is pivotable about an edge of the substantially planar wall with respect to the main body

7. A cabin module according to claim 1, comprising furniture having a stowed position when the module is in the closed configuration, and a deployed position when the module is in the open configuration, in which the furniture is moveable between the stowed position and the deployed position in response to movement of one or more of the external walls.

8. A cabin module according to claim 7, in which the furniture is foldable and able to reversibly fold and unfold between the stowed position and the deployed position in response to movement of one or more of the external walls.

9. A cabin module according to claim 7, in which the furniture is slidable with respect to the module between the stowed position and the deployed position in response to movement of one or more of the external walls.

10. A cabin module according to claim 1, comprising a locking mechanism having a locked position and an unlocked position, in which the locking mechanism is moveable between the locked position and the unlocked position, and the locking mechanism is arranged to be able to hold the module in the open configuration when the locking mechanism is in the locked position.

11. A cabin module according to claim 10, in which one or more of the external walls are able to move between the closed configuration and the open configuration when the locking mechanism is in the unlocked position.

12. A cabin module according to claim 10, in which the locking mechanism is arranged to be able to hold the module in the closed configuration when the locking mechanism is in the locked position.

13. A cabin module according to claim 10, in which the locking mechanism is able to cooperate with at least a portion of the vehicle so as to be able to hold the module in the open configuration.

14. A cabin module according to claim 1, in which:
the cabin module is a passenger cabin module for interaction with one or more passengers; and
the cabin module is configured as one or more of:
a gym;
a spa;
a bar;
a games area;
a seating area; and
a sleeping area.

15. A vehicle comprising a cabin module according to claim 1.

16. A vehicle or a cabin module according to claim 1, in which the vehicle is an aircraft.
